(19) United States
(12) Patent Application Publication
(10) Pub. No.: US 2008/0196244 A1
(43) Pub. Date: Aug. 21, 2008

(54) Electrical outlet cover remover

(76) Inventor: David R. Miglin, Alpharetta, GA (US)

Correspondence Address: Timothy S. Stevens, Patent Attorney, 5108 Foxpoint Circle, Midland, MI, 48642, US

(21) Appl. No.: 12/069,751

(22) Filed: Feb. 13, 2008

Related U.S. Application Data
(60) Provisional application No. 60/901,917, filed on Feb. 16, 2007.

(51) Int. Cl. H01R 43/00

(52) U.S. Cl. 29/764; 29/729; 29/759

(57) ABSTRACT

An article of manufacture for removing outlet safety covers from electrical outlets. The invention consists of an elongated body having a first end, a second opposite end, a first side and a second opposite side, the first end of the body terminating in a curved chisel shape curving toward the first side of the body, the body defining at least two tabs extending therefrom positioned near the second end of the body in a direction from the second side of the body, the first end of the body being dimensioned for enabling the first end of the body to wedge between a pair of prongs of an outlet safety cover to remove the cover, the tabs being dimensioned to grasp an electrical cord.

This application claims the benefit of priority to U.S. Patent Application Ser. No. 60/901,917 filed Feb. 16, 2007. The present invention relates generally to an electrical outlet safety cover remover, and more particularly relates to a tool which is used to conveniently pry a safety cover from an electrical outlet.

### BACKGROUND OF THE INVENTION

Electrical outlet safety plugs, or covers, provide an effective way to prevent shock injuries, but unfortunately they are difficult and inconvenient to remove from the outlets. The typical outlet plug comprises a flat cover having two non-conductive prongs that are plugged into the outlet receptacles. Once inserted into an outlet, the cover cannot be easily removed from the outlet because it lies flush against the outlet plate. As a result, removal of the cover is usually carried out by prying the cover from the outlet with a foreign object or a finger nail. While safety covers are used to prevent children and adults from inadvertently inserting a finger or metal object into the electrical receptacles, the danger and inconvenience associated with safety covers remains. Lyonnais provided a tool for prying safety covers from electrical outlets (U.S. Pat. No. 5,625,943). However, the tool provided by Lyonnais provided no means for ready access when needed. Consequently, there exists a need for a simple tool which can be used to safely pry conventional electrical outlet safety plugs from their outlets and which has a means for ready access when needed.

### SUMMARY OF THE INVENTION

It is an object of the present invention to provide a tool for removing electrical outlet safety plugs from electrical outlets which is convenient and safe to use.

It is another object of the invention to provide an electrical outlet safety cover remover that allows the continued use of inexpensive, conventional, outlet plugs which are presently in widespread use.

It is a further object of the invention to provide an electrical outlet safety plug remover that may be easily and conveniently attached to an electrical cord (for example the electrical cord of a vacuum cleaner) for ready access when needed.

It is also an object of this invention to provide an electrical outlet safety cover remover that is simple in design and construction, and low in cost.

In accordance with these and other objects, the present invention is an article of manufacture for removing outlet safety covers from electrical outlets, comprising: an elongated body having a first end, a second opposite end, a first side and a second opposite side, the first end of the body terminating in a curved chisel shape curving toward the first side of the body, the body defining at least two tabs extending therefrom positioned near the second end of the body in a direction from the second side of the body, the first end of the body being dimensioned for enabling the first end of the body to wedge between a pair of prongs of an outlet safety cover to remove the cover, the tabs being dimensioned to grasp an electrical cord.

### BRIEF DESCRIPTION OF THE DRAWINGS

FIG. 1 is a perspective view of a preferred embodiment of the instant invention; and

FIG. 2 is a top view of the embodiment shown in FIG. 1.

### DETAILED DESCRIPTION

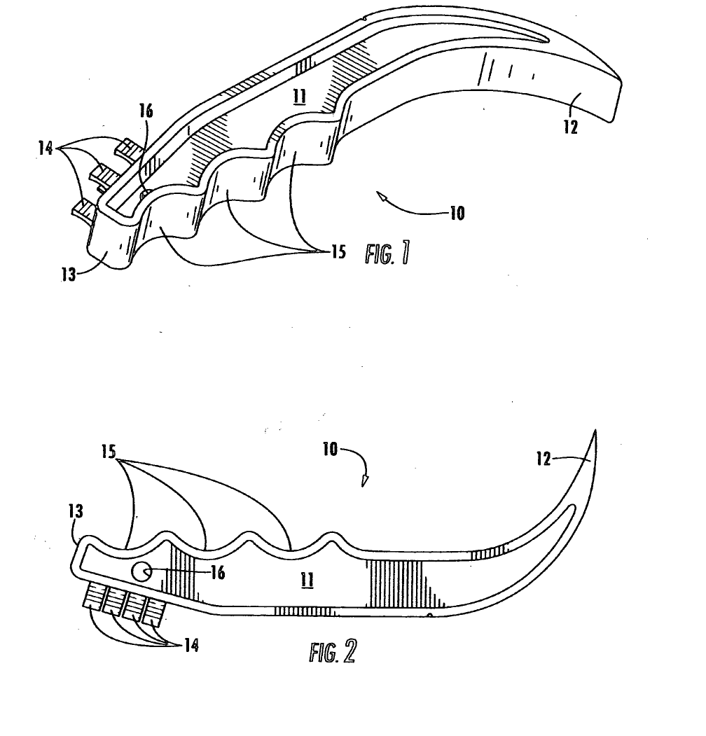

Referring now to FIGS. 1 and 2, therein is shown a preferred article of manufacture 10 according to the instant invention. The article of manufacture 10 can be used for removing outlet safety covers from electrical outlets. The article of manufacture 10, comprises an elongated body 11 having a first end 12, a second opposite end 13, a first side and a second opposite side, the first end 12 of the body terminating in a curved chisel shape curving toward the first side of the body, the body defining tabs 14 extending therefrom positioned near the second end 13 of the body in a direction from the second side of the body, the first end 12 of the body being dimensioned for enabling the first end of the body 12 to wedge between a pair of prongs of an outlet safety cover to remove the cover, the curved shape of the first end 12 of the body 11 providing increased and smoothly applied leverage in removing the cover, the tabs 14 being dimensioned to grasp an electrical cord for convenient storage of the article 10 on, for example, the electrical cord of a vacuum cleaner. Preferably the body 11 defines indentations 15 as a finger hold. The body 11 can optionally define an aperture therethrough 16 (located as shown or elsewhere in the body 11) to accommodate, for example, a lanyard or other means for carrying the article of manufacture 10. The article of manufacture 10 can be made from any desired material. However, the article of manufacture 10 is preferably injection molded from a non-conductive thermoplastic polymer such as polystyrene, polyethylene, polypropylene or a similar material.

### CONCLUSION

While the instant invention has been described above according to its preferred embodiments, it can be modified within the spirit and scope of this disclosure. This application is therefore intended to cover any variations, uses, or adaptations of the instant invention using the general principles disclosed herein. Further, the instant application is intended to cover such departures from the present disclosure as come within the known or customary practice in the art to which this invention pertains and which fall within the limits of the following claims.

1. An article of manufacture for removing outlet safety covers from electrical outlets, comprising: an elongated body having a first end, a second opposite end, a first side and a second opposite side, the first end of the body terminating in a curved chisel shape curving toward the first side of the body, the body defining at least two tabs extending therefrom positioned near the second end of the body in a direction from the second side of the body, the first end of the body being dimensioned for enabling the first end of the body to wedge between a pair of prongs of an outlet safety cover to remove the cover, the tabs being dimensioned to grasp an electrical cord.

2. The article of manufacture of claim 1, further comprising indentations formed on the first side of the body dimensioned to generally conform to the fingers of a hand.

3. The article of manufacture of any of claims 1 or 2, molded from a non-conductive thermoplastic polymer.

4. An improved electrical outlet safety cover remover having an elongated body, wherein the improvement comprises the body defining at least two tabs extending therefrom, the tabs being dimensioned to grasp an electrical cord.
